(19) United States
(12) Patent Application Publication
(10) Pub. No.: US 2026/0014901 A1
(43) Pub. Date: Jan. 15, 2026

(54) Vehicle Battery Preheating Method

(71) Applicant: Shenzhen Mingtang New Energy Technology Co., Ltd., Shenzhen (CN)

(72) Inventors: Mingxiang Luo, Shenzhen (CN); Yingjun Diao, Shenzhen (CN); Wujun Zeng, Shenzhen (CN); Zhiru Li, Shenzhen (CN)

(73) Assignee: Shenzhen Mingtang New Energy Technology Co., Ltd., Shenzhen (CN)

(21) Appl. No.: 19/194,076

(22) Filed: Apr. 30, 2025

(30) Foreign Application Priority Data
Jul. 10, 2024 (CN) 202410923192.7

(51) Int. Cl. B60L 58/27

(52) U.S. Cl. CPC B60L 58/27; B60L 2240/662; B60L 2260/56

(57) ABSTRACT

The present invention relates to the field of electric vehicle control and discloses a vehicle battery preheating method, including: acquiring an arrival time of preset weather and acquiring a vehicle usage time of a user; determining a duration for which a vehicle battery is in a low-temperature state based on the arrival time of the preset weather and the vehicle usage time, the low-temperature state being a state where a temperature is below a preset temperature threshold; and preheating the vehicle battery based on the duration for which the vehicle battery is in the low-temperature state. With this solution, the present invention facilitates estimating whether the vehicle battery will be fully frozen before a next use, effectively preventing the vehicle battery from being fully frozen when extremely cold weather arrives.

### RELATED APPLICATIONS

The present patent document claims the benefit of priority to patent application Ser. No. 20/241,0923192.7, filed Jul. 10, 2024, and entitled “Vehicle Battery Preheating Method,” the entire contents of each of which are incorporated herein by reference.

### TECHNICAL FIELD

The present invention relates to the field of electric vehicle control, and particularly relates to a vehicle battery preheating method.

### BACKGROUND INFORMATION

A battery is an important component of an electric vehicle, affecting performances such as vehicle range, lifespan, and safety. Many factors influence the performance of a vehicle battery, with temperature being the most significant one.

In a low-temperature environment, especially during rapid cooling caused by a cold wave, a vehicle battery is prone to being fully frozen. Prolonged freezing of the battery significantly adversely affects the performance and lifespan of the battery. The battery requires a larger current to start, meaning that charging in low temperatures becomes more difficult and may fail to achieve an expected charging effect. Freezing of the battery can cause an electrolyte of the battery to freeze, potentially leading to cracking of a battery casing or deformation of electrode plates, exerting pressure on an internal structure of the battery. These physical changes severely damage structural integrity of the battery. Freezing of the electrolyte may also cause active material inside the battery to detach, and detachment of the active material directly affects capacity and performance of the battery, thereby significantly shortening lifespan of the battery.

### BRIEF SUMMARY

A primary objective of the present invention is to address a technical problem of a vehicle battery being fully frozen in a low-temperature environment.

A first aspect of the present invention provides a vehicle battery preheating method, where the vehicle battery preheating method includes:

acquiring an arrival time of preset weather and acquiring a vehicle usage time of a user;

determining a duration for which a vehicle battery is in a low-temperature state based on the arrival time of the preset weather and the vehicle usage time, where the low-temperature state is a state where a temperature is below a preset temperature threshold; and

preheating the vehicle battery based on the duration for which the vehicle battery is in the low-temperature state.

Optionally, in a first implementation of the first aspect of the present invention, the acquiring an arrival time of preset weather includes:

acquiring a vehicle position corresponding to a vehicle battery; and

acquiring the arrival time of the preset weather based on the vehicle position.

Optionally, in a second implementation of the first aspect of the present invention, the acquiring the arrival time of the preset weather based on the vehicle position includes:

acquiring weather forecast information corresponding to the vehicle position; and

acquiring the arrival time of the preset weather from the weather forecast information.

Optionally, in a third implementation of the first aspect of the present invention, the acquiring a vehicle usage time of a user includes: acquiring a vehicle position corresponding to a vehicle battery; and

acquiring the vehicle usage time of the user based on the vehicle position.

Optionally, in a fourth implementation of the first aspect of the present invention, the determining a duration for which a vehicle battery is in a low-temperature state based on the arrival time of the preset weather and the vehicle usage time includes:

determining a duration between the vehicle usage time and the arrival time of the preset weather as the duration for which the vehicle battery is in the low-temperature state.

Optionally, in a fifth implementation of the first aspect of the present invention, the preheating the vehicle battery based on the duration for which the vehicle battery is in the low-temperature state includes:

preheating the vehicle battery in a case where the duration for which the vehicle battery is in the low-temperature state reaches a set time threshold.

In the embodiments of the present invention, determining the duration for which a vehicle battery is in a low-temperature state facilitates estimating whether the vehicle battery will be fully frozen before a next use, and preheating the vehicle battery based on the duration for which the vehicle battery is in the low-temperature state can effectively prevent the vehicle battery from being fully frozen when extremely cold weather arrives.

### BRIEF DESCRIPTION OF THE DRAWINGS

FIG. 1 is a schematic diagram of an embodiment of a vehicle battery preheating method in embodiments of the present invention.

### DETAILED DESCRIPTION OF THE DRAWINGS AND THE PRESENTLY PREFERRED EMBODIMENTS

Embodiments of the present invention provide a vehicle battery preheating method.

Embodiments disclosed by the present invention will be described in more detail below with reference to the accompanying drawings. Although some embodiments disclosed by the present invention are shown in the drawings, the present invention disclosure can be implemented in various forms and should not be construed as limited to the embodiments set forth herein; rather, these embodiments are provided for a more thorough and complete understanding of the present disclosure. The drawings and embodiments disclosed by the present invention are for exemplary purposes only and are not intended to limit the scope of protection of the present invention disclosure.

In the description of the embodiments disclosed by the present invention, the term “include” and similar expressions should be understood as open-ended inclusion, meaning “including but not limited to”. The term “based on” should be understood as “based at least in part on”. The term “an embodiment” or “the embodiment” should be understood as “at least one embodiment”. The terms “first”, “second”, and the like may refer to different or the same objects. Other explicit and implicit definitions may also be included below.

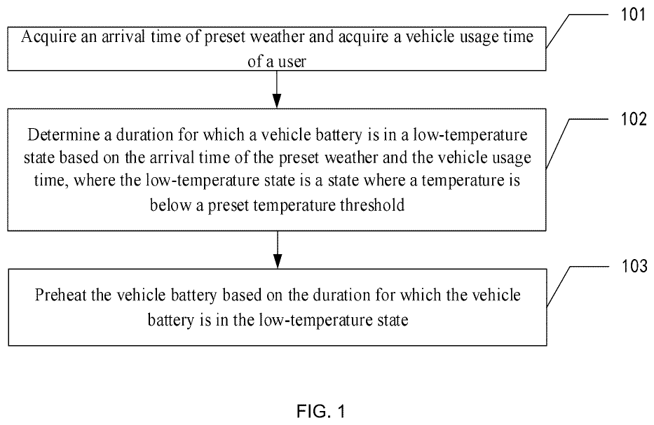

For ease of understanding, a specific process of an embodiment of the present invention is described below. Referring to FIG. 1, an embodiment of a vehicle battery preheating method in the embodiments of the present invention includes:

101. Acquire an arrival time of preset weather and acquire a vehicle usage time of a user.

102. Determine a duration for which a vehicle battery is in a low-temperature state based on the arrival time of the preset weather and the vehicle usage time, where the low-temperature state is a state where a temperature is below a preset temperature threshold.

103. Preheat the vehicle battery based on the duration for which the vehicle battery is in the low-temperature state.

Specifically, the preset weather is weather such as a cold wave/cold current.

The above solution facilitates estimating whether a vehicle battery will be fully frozen before a next use by determining the duration for which the vehicle battery is in a low-temperature state and can effectively prevent the vehicle battery from being fully frozen when cold weather arrives by preheating the vehicle battery based on the duration for which the vehicle battery is in the low-temperature state.

In some embodiments, the acquiring an arrival time of preset weather includes: acquiring a vehicle position corresponding to a vehicle battery; and acquiring the arrival time of the preset weather based on the vehicle position. Acquiring the vehicle position facilitates more accurately understanding weather conditions at different locations, thereby preparing for subsequent preheating.

Further, the acquiring the arrival time of the preset weather based on the vehicle position includes: acquiring weather forecast information corresponding to the vehicle position; and acquiring the arrival time of the preset weather from the weather forecast information. The weather forecast information includes weather information and a corresponding arrival time, as well as a duration of the weather. Therefore, through weather forecast information for different locations, whether preset weather such as a cold wave is arriving can be determined, and an arrival time and duration corresponding to specific weather can also be obtained, thereby enabling determination of a temperature state of a vehicle using the preset weather.

In some embodiments, the acquiring a vehicle usage time of a user includes: acquiring a vehicle position corresponding to a vehicle battery; and acquiring the vehicle usage time of the user based on the vehicle position. Specifically, after obtaining the vehicle position, a table lookup operation is performed in a preset vehicle usage time database to obtain the vehicle usage time corresponding to different vehicle positions. The vehicle usage time database stores a mapping relationship among vehicle number, user, vehicle position, and vehicle usage time of the user.

With the above solution, a vehicle usage time database can be prepared in advance, and when preheating the vehicle battery, the vehicle usage time of the user can be obtained as long as the vehicle position is acquired, facilitating determination of the duration for which the vehicle battery is in the low-temperature state based on the vehicle usage time.

In some embodiments, the determining a duration for which a vehicle battery is in a low-temperature state based on the arrival time of the preset weather and the vehicle usage time includes: determining a duration between the vehicle usage time and the arrival time of the preset weather as the duration for which the vehicle battery is in the low-temperature state. For example, if the arrival time of the preset weather is 23:00 and the vehicle usage time of the user is 07:00, there are 8 hours between 23:00 and 07:00, and the duration for which the vehicle battery is in the low-temperature state is determined to be 8 hours.

In some embodiments, the preheating the vehicle battery based on the duration for which the vehicle battery is in the low-temperature state includes: preheating the vehicle battery in a case where the duration for which the vehicle battery is in the low-temperature state reaches a set time threshold. In this manner, whether the vehicle battery will be fully frozen can be easily determined, thereby facilitating control of preheating of the vehicle battery to prevent the vehicle battery from being fully frozen.

Optionally, in some other embodiments, the acquiring an arrival time of preset weather includes:

performing big data analysis based on historical weather conditions to obtain the arrival time of the preset weather.

Specifically, historical weather forecast information for a preset time period and actual weather information corresponding to the preset time period are collected. The historical weather forecast information includes these corresponding to preset location information: historical weather information and corresponding arrival times, and durations of the historical weather. The actual weather information corresponding to the preset time period includes these corresponding to the preset location information: actual weather information and corresponding arrival times, and durations of the actual weather. The historical weather forecast information for the preset time period is used as training samples for a forecast model, and the actual weather information corresponding to the preset time period is used as sample labels. A forecast model sample is trained using a neural network model to obtain a weather forecast model. For acquiring the arrival time of the preset weather, current weather forecast information is collected and input into the weather forecast model to obtain weather information and a corresponding arrival time, as well as a duration of the weather. The obtained weather information includes weather such as a cold current/cold wave.

Optionally, in some other embodiments, the acquiring a vehicle usage time of a user includes: predicting the vehicle usage time of the user using a vehicle usage habit of the user.

Specifically, the vehicle usage habit of the user includes: a driving trajectory and a departure time corresponding to a trajectory starting position. In some embodiments, locations of the user going to work and returning home and corresponding departure times are acquired. When the electric vehicle is at a starting position in a historical driving trajectory, a corresponding departure time can be matched as the predicted vehicle usage time of the user.

Optionally, in some other embodiments, the acquiring a vehicle usage time of a user includes:

acquiring a user-set vehicle usage time, acquiring a travel adjustment time corresponding to preset weather, and predicting the vehicle usage time of the user based on the travel adjustment time and the user-set vehicle usage time.

The user-set vehicle usage time is a vehicle usage time input by the user through a user terminal such as a smartphone, tablet, or computer. The user can also input information such as a vehicle number through the user terminal. Optionally, the user-set vehicle usage time and/or the vehicle number input by the user is stored in a user vehicle usage time database, thus obtaining a user vehicle usage time database storing a mapping relationship among vehicle number, user, and vehicle usage time of the user.

Further, the acquiring a travel adjustment time corresponding to the preset weather includes:

after acquiring weather forecast information corresponding to a vehicle position, further including: sending the weather forecast information to a user terminal and triggering the user terminal to feed back a reading situation for the weather forecast information. The reading situation includes a reaction time for viewing the weather forecast, a dwell time spent viewing the weather forecast, and the number of times the weather forecast is viewed. The travel adjustment time corresponding to the preset weather is acquired based on the dwell time, the reaction time, and the number of times.

Specifically, the electric vehicle or a server sends the weather forecast information to the user terminal via email, SMS, or APP notification. After receiving the weather forecast information sent by the electric vehicle or the server, the user terminal records a time when the user terminal receives the weather forecast information, a time when the weather forecast information is first viewed, and the number of times the weather forecast information is tapped. The duration from when the weather forecast information is opened to when the weather forecast information is closed is determined as the dwell time spent viewing the weather forecast information. If the weather forecast information is tapped multiple times, a sum of the dwell times spent viewing the weather forecast information for the taps is determined as the dwell time spent viewing the weather forecast information. Specifically, a time when the weather forecast information is first tapped is determined as a time when the user first views the weather forecast. Specifically, a reaction time for the user viewing the weather forecast is identified as a difference between the time when the user terminal receives the weather forecast and the time when the weather forecast is first viewed.

Specifically, the acquiring the travel adjustment time corresponding to the preset weather based on the dwell time, the reaction time, and the number of times includes:

calculating

$${T}_{ad} = \frac{\partial }{{T}_{re}} \times {T}_{set 1} + β \times {T}_{stay} + {F}_{read} \times {T}_{set 2}$$

to obtain the travel adjustment time corresponding to the preset weather. Here, T_{ad} is the travel adjustment time corresponding to the preset weather, ∂ is a preset first adjustment coefficient, Tᵣₑ is the reaction time for viewing the weather forecast, Tₛₑₜ₁ is a preset first time length value, β is a preset second adjustment coefficient, R_{stay} is the dwell time spent viewing the weather forecast, and F_{read} is the number of times the weather forecast is viewed, Tₛₑₜ₁ is a preset second time length value, where ∂>0, Tₛₑₜ₁>0and Tₛₑₜ₂>0.

Specifically,

$$β \{ \begin{matrix}A , if {T}_{re} < {T}_{y 1} and {T}_{stay} < {T}_{y 2} and {F}_{read} < {F}_{y} \\ α \times A , if {T}_{re} > {T}_{y 3} and {T}_{stay} > {T}_{y 4} and {F}_{read} < {F}_{y} \\ δ \times A , else\end{matrix} .$$

Here, A is a preset third adjustment coefficient, A>1, α is a preset fourth adjustment coefficient, α>1, T_{y1} is a preset first time length threshold, T_{y1} is a preset second time length threshold, F_{y} is a preset number threshold, T_{y3} is a preset third time length threshold, T_{y4} is a preset fourth time length threshold, and δ is a preset fifth adjustment coefficient, where 0<δ<1. T_{y1}, T_{y2}, F_{y}, T_{y3}, and T_{y4} are all greater than 0.

Specifically, the vehicle usage time of the user is obtained by calculating T_{c}=T_{yh}−T_{ad}. Here, T_{ad} is the travel adjustment time, T_{yh} is the user-set vehicle usage time, and T_{c} is the vehicle usage time of the user.

In the above solution, an impact of the weather forecast on the user's travel is reflected by using the reaction time for viewing the weather forecast, the dwell time spent viewing the weather forecast, and the number of times the weather forecast is viewed, thereby estimating an adjustment time that the user may need for a travel journey, and further adjusting an estimation of the vehicle usage time of the user, facilitating more precise preheating of the battery of the electric vehicle. When the reaction time for viewing the weather forecast, the dwell time spent viewing the weather forecast, and the number of times the weather forecast is viewed are all less than preset thresholds, it easily reflects that the user quickly views the weather forecast information. When the reaction time for viewing the weather forecast and the dwell time spent viewing the weather forecast are greater than preset thresholds, and the number of times the weather forecast is viewed is less than a preset threshold, it easily reflects that the user views the weather forecast information carefully and pays more attention to the route and travel duration, and therefore an impact of the dwell time on the adjustment time is increased. In other cases, the impact of the dwell time on the adjustment time is reduced. The method of acquiring the second adjustment coefficient corresponding to the dwell time spent viewing the weather forecast can estimate a degree of influence of the weather forecast on the user's adjustment of travel time based on different behaviors of the user viewing the weather forecast information, enabling a more accurate estimation of the vehicle usage time of the user and thus better determining a timing for preheating the vehicle battery.

Optionally, in some embodiments, the preheating the vehicle battery based on the duration for which the vehicle battery is in the low-temperature state includes:

determining a preheating start time in a case where the duration for which the vehicle battery is in the low-temperature state reaches a set time threshold, and preheating the vehicle battery when the preheating start time is reached.

Specifically, the preheating start time is determined by calculating

$${T}_{start} = {T}_{L} + \frac{{T}_{set 3}}{{T}_{ad}} .$$

Here, Tₛₜₐᵣₜ is the preheating start time, T_{L} is the arrival time of the preset weather, Tₛₑₜ₃ is a preset third time length value, and Tₛₑₜ₃>0. The above solution facilitates timely preheating after the arrival of cold weather, effectively preventing the vehicle battery from being fully frozen. Moreover, the longer the travel adjustment time, the earlier the preheating starts, ensuring that the battery temperature remains within an appropriate range even when the user needs to use the vehicle earlier due to weather conditions.

The technical solution of the embodiments of the present disclosure can be embodied in the form of a software product, where the computer software product is stored in a storage medium and includes one or more instructions to enable a computer device (which may be a personal computer, a server, or a network device, etc.) to execute all or part of the steps of the method described in the embodiments of the present disclosure. The aforementioned storage medium may be a non-transitory storage medium, including: a USB flash drive, a portable hard disk, a read-only memory (ROM, Read-Only Memory), a random access memory (RAM, Random Access Memory), a magnetic disk, or an optical disk, among various media capable of storing program code, or may be a transitory storage medium.

The above description and drawings sufficiently illustrate the embodiments of the present disclosure to enable persons skilled in the art to practice them. Other embodiments may include structural, logical, electrical, procedural, and other changes. The embodiments represent only possible variations. Unless explicitly required, individual components and functions are optional, and the order of operations may vary. Portions and features of some embodiments may be included in or substituted for portions and features of other embodiments. Moreover, the terms used in this application are used only to describe the embodiments and are not intended to limit the claims. As used in the description of the embodiments and the claims, unless the context clearly indicates otherwise, the singular forms “a”, “an”, and “the” are intended to include the plural forms as well. Similarly, the term “and/or” as used in this application refers to any and all possible combinations of one or more associated listed items. Additionally, when used in this application, the term “comprise” and its variants “comprises” and/or “comprising” refer to the presence of stated features, entireties, steps, operations, elements, and/or components, but do not preclude the presence or addition of one or more other features, entireties, steps, operations, elements, components, and/or groups thereof. In the absence of further limitations, an element defined by the phrase “comprising a . . . ” does not exclude the presence of additional identical elements in a process, method, or device that includes the element. Herein, each embodiment may focus on differences from other embodiments, and identical or similar parts between the embodiments may be referenced between each other. For a method, product, or the like disclosed in an embodiment, if the method, product, or the like corresponds to the method disclosed in an embodiment, reference may be made to the description of the method for relevant details.

Persons skilled in the art can realize that the units and algorithm steps of the examples described in conjunction with the embodiments disclosed herein can be implemented by electronic hardware, or a combination of computer software and electronic hardware. Whether these functions are performed in hardware or software may depend on specific applications and design constraints of the technical solution. The skilled person may use a different method for each specific application to implement the described functions, but such implementation should not be considered beyond the scope of the embodiments of the present disclosure. The skilled person can clearly understand that, for convenience and brevity of description, the specific working processes of the systems, apparatuses, and units described above may be learned by making reference to the corresponding processes in the foregoing method embodiments and will not be repeated herein.

In the embodiments disclosed herein, the disclosed methods and products (including but not limited to apparatuses and devices) may be implemented in other ways. For example, the apparatus embodiments described above are merely illustrative. For instance, the division of the units may be merely a logical function division, and there may be other division manners in actual implementation, such as multiple units or components being combined or integrated into another system, or some features being omitted or not executed. Additionally, the mutual coupling or direct coupling or communication connection shown or discussed may be an indirect coupling or communication connection through some interfaces, apparatuses, or units, and may be in electrical, mechanical, or other forms. The units described as separate components may or may not be physically separate, and components displayed as units may or may not be physical units, meaning that they may be located in one place or distributed across multiple network units. Some or all of the units may be selected according to actual needs to implement this embodiment. Furthermore, the functional units in the embodiments of the present disclosure may be integrated into one processing unit, or each unit may exist physically separately, or two or more units may be integrated into one unit.

The flowcharts and block diagrams in the accompanying drawings illustrate possible architectures, functions, and operations of systems, methods, and computer program products according to the embodiments of the present disclosure. In this regard, each block in the flowchart or block diagram may represent a module, a program segment, or a portion of code, where the module, program segment, or portion of code contains one or more executable instructions for implementing a specified logical function. In some alternative implementations, the functions noted in the blocks may occur in an order different from that noted in the drawings. For example, two consecutive blocks may be executed substantially in parallel, or they may sometimes be executed in a reverse order, depending on the functions involved. In the descriptions corresponding to the flowcharts and block diagrams in the drawings, operations or steps corresponding to different blocks may also occur in an order different from that disclosed in the description, and sometimes there is no specific order between different operations or steps. For example, two consecutive operations or steps may be executed substantially in parallel, or they may sometimes be executed in a reverse order, depending on the functions involved. Each block in the block diagrams and/or flowcharts, and combinations of blocks in the block diagrams and/or flowcharts, may be implemented by a dedicated hardware-based system that performs specified functions or actions, or by a combination of dedicated hardware and computer instructions.

1. A vehicle battery preheating method, wherein the vehicle battery preheating method comprises: acquiring an arrival time of preset weather and acquiring a vehicle usage time of a user;
determining a duration for which a vehicle battery is in a low-temperature state based on the arrival time of the preset weather and the vehicle usage time, wherein the low-temperature state is a state where a temperature is below a preset temperature threshold; and
determining a preheating start time in a case where the duration for which the vehicle battery is in the low-temperature state reaches a set time threshold, and preheating the vehicle battery when the preheating start time is reached;
wherein the preheating start time is determined by calculating
$${T}_{start} = {T}_{L} + \frac{{T}_{set 3}}{{T}_{ad}} ;$$
Tₛₜₐᵣₜ is the preheating start time, T_{L} is the arrival time of the preset weather, T_{ad} is a travel adjustment time corresponding to the preset weather, Tₛₑₜ₃ is a preset third time length value, and Tₛₑₜ₃>0;
wherein the travel adjustment time corresponding to the preset weather is acquired in the following manner: acquiring a vehicle position corresponding to the vehicle battery, acquiring weather forecast information corresponding to the vehicle position, sending the weather forecast information to a user terminal, and triggering the user terminal to feed back a reading situation for the weather forecast information, wherein the reading situation comprises a reaction time for viewing the weather forecast, a dwell time spent viewing the weather forecast, and the number of times the weather forecast is viewed; and acquiring the travel adjustment time corresponding to the preset weather based on the dwell time, the reaction time, and the number of times.

2. The vehicle battery preheating method according to claim 1, wherein the acquiring an arrival time of preset weather comprises:
acquiring the vehicle position corresponding to the vehicle battery; and
acquiring the arrival time of the preset weather based on the vehicle position.

3. The vehicle battery preheating method according to claim 2, wherein the acquiring the arrival time of the preset weather based on the vehicle position comprises:
acquiring the weather forecast information corresponding to the vehicle position; and
acquiring the arrival time of the preset weather from the weather forecast information.

4. The vehicle battery preheating method according to claim 1, wherein the acquiring a vehicle usage time of a user comprises:
acquiring the vehicle position corresponding to the vehicle battery; and
acquiring the vehicle usage time of the user based on the vehicle position.

5. The vehicle battery preheating method according to claim 1, wherein the determining a duration for which a vehicle battery is in a low-temperature state based on the arrival time of the preset weather and the vehicle usage time comprises: determining a duration between the vehicle usage time and the arrival time of the preset weather as the duration for which the vehicle battery is in the low-temperature state.
